(19) United States
(12) Patent Application Publication
(10) Pub. No.: US 2014/0178827 A1
(43) Pub. Date: Jun. 26, 2014

(54) FIREPROOF CONTAINER IMPROVED IN CIRCULATION OF HEAT AND SAFETY OF USE

(71) Applicant: YJC CO., LTD., Jeollanam-do (KR)

(72) Inventors: Sang Moon NA, Gwangju (KR); Seung Il KIM, Gwangju (KR); Ji Hoon PARK, Gwangju (KR)

(73) Assignee: YJC CO., LTD., Jeollanam-do (KR)

(21) Appl. No.: 14/107,790

(22) Filed: Dec. 16, 2013

(30) Foreign Application Priority Data
Dec. 24, 2012 (KR) 10-2012-0151956
Nov. 29, 2013 (KR) 10-2013-0147166

(51) Int. Cl. F27D 5/00

(52) U.S. Cl. CPC F27D 5/0068
USPC 432/261

(57) ABSTRACT

This invention relates to a fireproof container with improved circulation of heat and safer use. According to an embodiment of this invention, a fireproof container, to be loaded in an industrial furnace to perform a thermal treatment of a powder or a target, includes a prominent member formed on the outer walls thereof Also, according to another embodiment of this invention, a fireproof container for use in thermal treatments has a hexahedral shape with a space having a predetermined volume in which a powder or a target to be thermally treated is placed, and includes a protrusion block having a predetermined shape formed on at least one of the external front surface, rear surface, left side surface, and right side surface of the fireproof container.

### CROSS-REFERENCE TO RELATED APPLICATION

This application claims priority to Korean Patent Application Nos. 10-2012-0151956, filed De. 24, 2012 and 10-2013-0147166, filed Nov. 29, 2013, in the Korean Intellectual Property Office, the entire disclosure of which is incorporated herein by reference.

### BACKGROUND

1. Field of the Invention

The present invention relates to a fireproof container for use in high-temperature thermal treatments of powders or parts, and more particularly, to a fireproof container, which increases linear movement thereof and does not shake when loading in an industrial furnace or kiln, or upon the general movement thereof, and thus mitigates breakdown or rollover incidents thereby facilitating maintenance intervals between the fireproof container and adjacent fireproof containers, making it possible to uniformly and efficiently circulate heat and gas during thermal treatments.

2. Description of the Related Art

For thermal treatments of predetermined targets at high temperatures, including the firing of electronic parts, such as ferrite, condensers, varistors, PTC, MLCC, and the like, necessary for advanced electronic industries, and the firing of metal or ceramic powder molded products, and the thermal treatment of metals and ceramic powders, and the like, a variety of thermal treatment furnaces including a car kiln, a RHK (Roller Hearth Kiln), a tunnel-type continuous furnace, a pusher-type continuous furnace, a vacuum sintering furnace, an elevator type furnace, and the like are being utilized.

In such thermal treatment furnaces, a fireproof container is used, wherein a firing target, such as a part or powder, is placed to safely and uniformly undergo thermal treatments at high temperature. In particular, a rectangular fireproof container is principally used, but a circular fireproof container may also be used. The term “fireproof container” may also be referred to as a melting pot, a box sagger, a tray, a crucible, a setter, and the like.

In the case of RHK, which is a typical continuous furnace, as illustrated in FIG. 5, the furnace itself is long at about 20 to 100 m, and includes a preheating zone 170, a firing zone 180, and a cooling zone 190 which are configured from the inlet of the furnace, and rollers 160, in a long pipe form made of alumina or silicon carbide, are arranged so that fireproof containers may be continuously and uni-directionally moved with respect to the total length of the RHK.

As the rollers 160 rotate at a predetermined rate, the fireproof containers move uni-directionally in the furnace in such a manner that the firing target 130 is thermally treated through the preheating zone 170 and the firing zone 180 at high temperatures, and then cooled through the cooling zone 190.

As illustrated in FIGS. 7A to 7D, the fireproof containers are arranged in up to four lines on the rollers 160 and thus may continuously move, and the intervals between the fireproof containers adjacent to each other are adjusted in consideration of the circulation of heat.

Conversely, in the case of a car kiln, which is a typical non-continuous furnace, the car kiln includes a car 150 having fireproof containers loaded thereon, as illustrated in FIG. 4, and a thermal treatment furnace body 140.

This car kiln is operated in such a manner that the fireproof containers containing firing targets 130 are loaded on the car 150 and then the car is placed in the body 140. Afterwards, the temperature of the body 140 is increased high enough to perform thermal treatment, and then the body 140 is cooled, followed by the car 150 being removed from the body.

As such, the fireproof containers are spaced apart from each other by a predetermined interval on the car 150 in order to achieve a level of heat circulation and uniform thermal treatment, and the fireproof containers are further superposed thereon to form multiple layers.

In other thermal treatment furnaces, including a tunnel-type continuous furnace, a pusher-type continuous furnace, a vacuum sintering furnace, an elevator-type furnace, and the like, in addition to the RHK and the car kiln, fireproof containers are used in a similar manner.

The fireproof containers are typically manufactured through the following processes.

Fireproof containers are made of a ceramic material, such as alumina, silica, magnesia, mullite, kaolin, clay, talc, spinel, chamotte, cordierite, and the like, which are composed of mainly of Al₂O₃, SiO₂, MgO, and the like.

These materials are used after having been ground to a powder having a particle size ranging from micrometers to millimeters.

The fireproof containers are manufactured using a press process or an injection molding process.

More specifically, a press process is performed by weighing individual materials in a powder phase at a mixing ratio depending on the properties (e.g., end use, use temperature, product shape, strength, etc.) required for the fireproof containers to be manufactured, then uniformly mixing them using a mixer, then adding water in an amount of 1 to 10%, based on the weight of the materials, to impart the powder material mixture with molding compactability, and then adding a binder, such as polyvinylalcohol, carboxymethyl cellulose, methylcellulose, and the like, a lubricant, and a releasing agent to improve the compactability, viscosity, releasability, and lubricating properties.

The material mixture having water and additives is prepared in this way, after which a mold for forming a rectangular or circular container is produced and mounted to a press, such as a hydraulic press, a frictional press, a vibration press, and the like, for applying high pressure, and then the material mixture having water and additives is placed in the mold and pressed using the press, thus forming a molded body for a rectangular or circular fireproof container.

The molded body is placed in a dryer and dried at 50° C. or higher for about 12 hr, so that the water content in the molded body is 1% or less.

The molded body is then fired in a kiln at 1200 to 1700° C. for 2 hr or more, thus completing the fireproof container having a predetermined strength through the sintering and thermochemical reactions of powder materials.

Conversely, an injection molding process is performed by weighing individual powdered materials with a mixing ratio depending on the properties (e.g., end use, use temperature, product shape, strength, etc.) required of the fireproof containers to be manufactured, then uniformly mixing them using a mixer, and then stirring the powdered material mixture along with 10 to 20% of water and a dispersant, a binder, or the like using a stirrer, thus making a viscous liquid.

When the viscous liquid is placed in a gypsum mold for forming the shape of a fireproof container, the gypsum absorbs the water from the viscous liquid. After a predetermined period of time, the viscous liquid is formed into a solid molded body having the shape of a fireproof container.

The molded body is then placed in a dryer and dried at 50° C. or higher for about 24 hr, so that the water content in the molded body is 1% or less.

The dried molded body is then fired in a kiln at 1200 to 1700° C. for 2 hr or more, thus completing a fireproof container having a predetermined strength through the sintering and thermochemical reactions of powder materials.

In a variety of industrial furnaces for thermal treatment, fireproof containers have been used to perform high-temperature thermal treatments of powder or targets having a predetermined shape, but many problems occur due to the structural features of the thermal treatment furnaces during their use, and there have been several accounts of their usage problems. More specifically, in the case of the RHK furnace, the length of the furnace itself ranges from 20 m to 100 m, and the fireproof containers are moved by the rotation of the rollers in the furnace.

As such, it is important that the fireproof containers are moved linearly throughout the furnace by the rotation of the rollers. For linear movement, the horizontal level of the rollers is accurately controlled, but linearity may deviate due to partial differences in the frictional resistance between the rollers and the fireproof containers.

More particularly, as illustrated in FIG. 6B, fireproof containers, which are spaced apart from each other by a predetermined interval in order to circulate heat, are introduced into the inlet of the furnace wherein the respective containers may slightly vary in their direction of travel and their travel rate(s) while passing through the inside of the furnace, and may thus be variably disposed at different intervals when reaching the outlet of the furnace, as illustrated in FIG. 7B, thereby undesirably deteriorating their temperature uniformity. In addition, the potential for non-linear movement of the fireproof containers may cause interference between each of the containers, and this would result in the fireproof containers colliding with the inner walls of the furnace, thereby undesirably damaging the inside of the furnace. In severe cases of such events, the insides of the furnace may partially breakdown, causing the furnace to not optimally operate.

Accordingly, with the goal of increasing the safe operation of RHK, as illustrated in FIG. 6A, the fireproof containers may be arranged without intervals therebetween. In this case, however, the circulation of heat in the furnace becomes poor because there are no intervals between the fireproof containers, and this circumstance undesirably lowers the uniformity of the thermal treatment temperatures.

In the case of the car kiln, as illustrated in FIGS. 8A and 8B, the fireproof containers are superposed in multiple layers on the car. As illustrated in FIG. 8A, when the fireproof containers are loaded without intervals therebetween, damage, due to shaking upon movement of the car(s) into the furnace body, to the firing targets and the fireproof containers may decrease, but then the circulation of the heat becomes poor, undesirably causing variations in thermal treatment temperatures in the furnace.

On the contrary, when the fireproof containers are spaced apart from each other, as illustrated in FIG. 8B, temperature variations may decrease thanks to the improvement in the circulation of the heat, but there is an increasing risk of damaging the firing targets and the fireproof containers due to vigorous shaking upon movement of the car, and in severe cases, the loaded fireproof containers may collapse, thus causing undesired incidents.

As mentioned above, the conventional fireproof containers are problematic in terms of the circulation of the heat upon thermal treatments and their safety of use.

### SUMMARY

Accordingly, in light of the above problems with the related art, one embodiment of the present invention is to provide a fireproof container that may efficiently circulate heat upon thermal treatments and may also be safely used.

None of the embodiments of the present invention are limited to the foregoing, and other embodiments not mentioned herein will be able to be clearly understood to those skilled in the art from the following description.

According to an embodiment of the present invention, a fireproof container with improved circulation of heat and improved safety of use is achieved the following descriptions.

More specifically, a fireproof container that is loaded in an industrial furnace for thermal treatments of powders or targets may include a prominent member formed on the outer walls thereof.

The prominent member is provided at an edge or the center of the outer walls of the fireproof container, and also is provided in a vertical or horizontal orientation to the outer walls of the fireproof container.

The prominent member is provided at an upper portion or a lower portion of the outer walls of the fireproof container, and also is provided at all of a left side surface, a right side surface, a front surface, and a rear surface of the outer walls of the fireproof container, or is provided only at any one of the left side surface, the right side surface, the front surface, or the rear surface thereof.

The prominent member is formed having an area corresponding to 40% or less of the total area of the outer walls of the fireproof container.

Alternatively, according to another embodiment of the present invention, a fireproof container encompasses improved circulation of the heat, and its safe use is achieved through the following descriptions.

More specifically, a fireproof container for use with thermal treatments may have a hexahedral shape with spaces having predetermined volumes wherein powders or targets to be thermally treated are placed, and may also include a protrusion block, having a predetermined shape, formed on at least one of external front surface, rear surface, left side surface, and right side surface of the fireproof container.

The protrusion block is formed on an upper portion, a lower portion, or a center of an external edge of the fireproof container, and also is formed on an upper portion, a lower portion, or a center of the external front surface, rear surface, left side surface, and right side surface of the fireproof container.

The protrusion block has a hexahedral shape with a protrusion height of 5 to 15 mm, and the protrusion block is integrally molded with the fireproof container to prevent separation from the fireproof container. The fireproof container and the protrusion block include any one, or a mixture of two or more, selected from the group consisting of alumina (Al₂O₃), silica (SiO₂), magnesia (MgO), zirconia (ZrO₂) and calcia (CaO).

The protrusion block is formed to occupy an area corresponding to 5 to 30% of a total area of the surface of the fireproof container on which the protrusion block is formed.

### BRIEF DESCRIPTION OF THE DRAWINGS

The above and other embodiments and advantages of the present invention will be more clearly understood from the following detailed description taken in conjunction with the accompanying drawings, wherein:

FIG. 1A illustrates a typical fireproof container, and FIGS. 1B to 1E illustrate fireproof containers with improved circulation of heat and their safer use according to one of the embodiments of the present invention;

FIGS. 2A and 2B are top plan views illustrating fireproof containers with improved circulation of heat and their safer use according to one embodiment of the present invention;

FIGS. 3A and 3B are side views illustrating the fireproof containers with improved circulation of heat and their safer use according to one embodiment of the present invention;

FIG. 4 illustrates the use of the fireproof containers in a car kiln;

FIG. 5 illustrates the use of the fireproof containers in RHK;

FIGS. 6A to 6D, 7A to 7D and 8A to 8D illustrate the arrangement and loading of the fireproof containers in a thermal treatment furnace.

### DETAILED DESCRIPTION

Although the terms used in the present invention are selected from among generally known and used terms, some of the terms mentioned in the description of the present invention have been selected by the applicant, the detailed meanings of which should be understood not simply by the actual terms used, but by the meaning of each term specifically used in the detailed description of the invention or in consideration of the contextual meanings used.

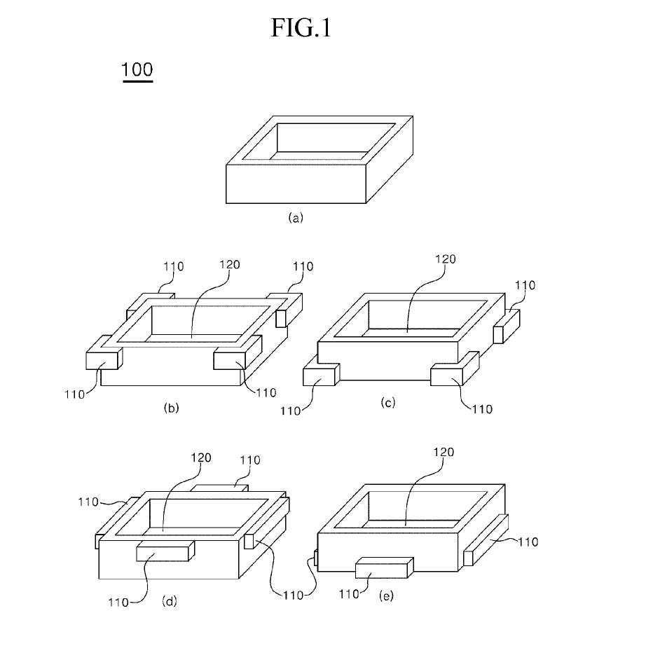

In this regard, FIG. 1A illustrates a typical fireproof container, and FIGS. 1B to 1E illustrate fireproof containers with improved circulation of heat and their safer use, according to one embodiment of the present invention.

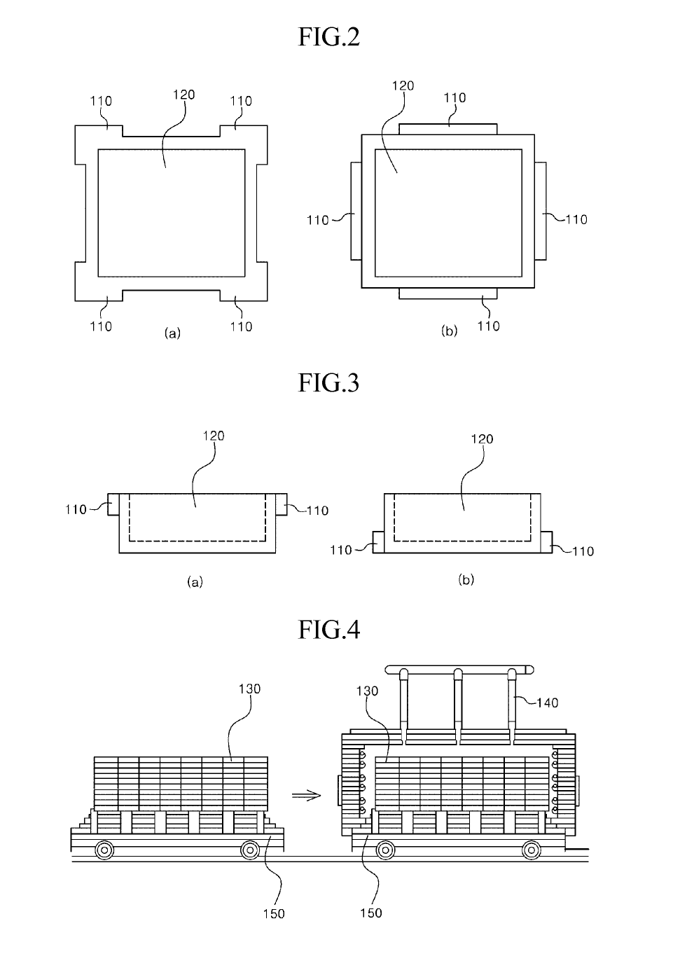

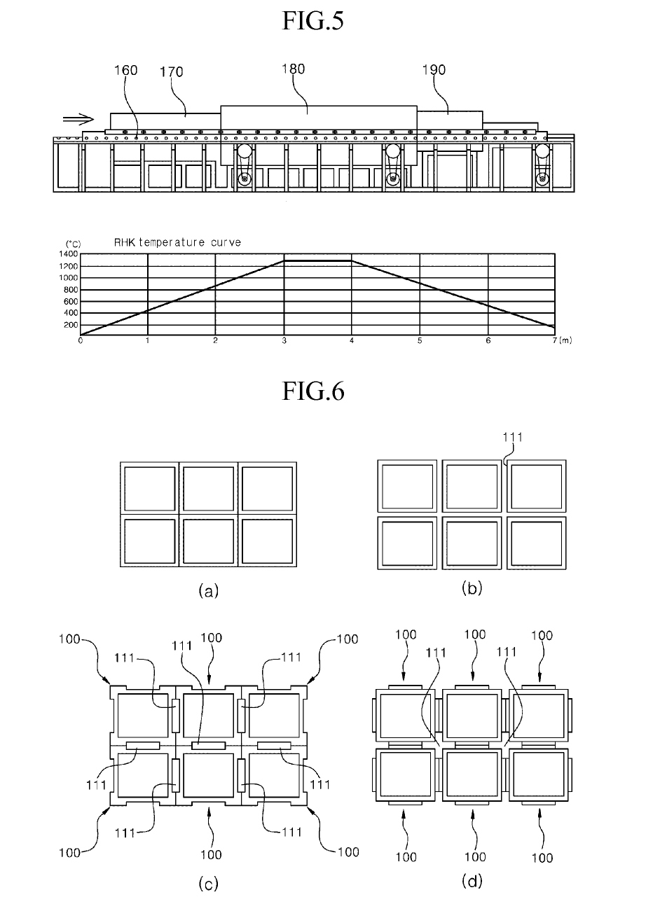

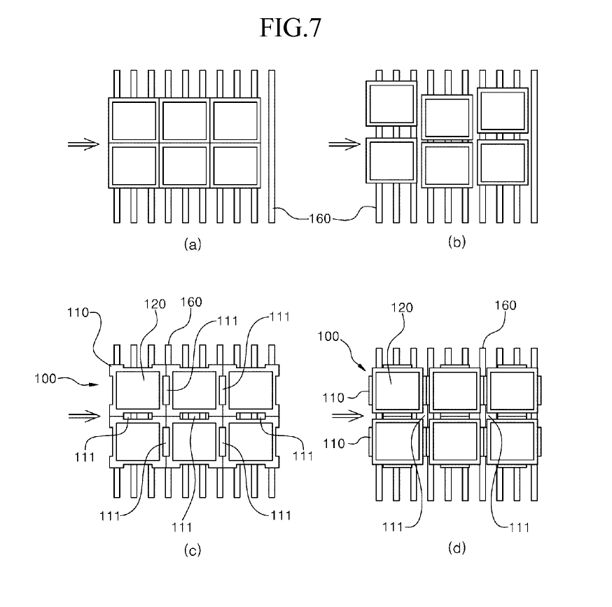

FIGS. 2A and 2B are top plan views illustrating fireproof containers with improved circulation of heat and their safer use, according to one embodiment of the present invention, FIGS. 3A and 3B are side views illustrating the fireproof containers with improved circulation of heat and their safer use, according to one embodiment of the present invention, FIG. 4 illustrates the use of fireproof containers in a car kiln, FIG. 5 illustrates the use of the fireproof containers in RHK, and FIGS. 6A to 6D, 7A to 7D and 8A to 8D illustrate the arrangement and loading of the fireproof containers in a thermal treatment furnace.

Hereinafter, a detailed description will be given of a fireproof container 100 with improved circulation of heat and its safer use, according to an embodiment of the present invention with reference to the appended drawings.

The fireproof container 100, with improved circulation of heat and its safer use, according to an embodiment of the present invention, includes a prominent member 110, having a predetermined size, formed on the outer wall thereof in order to improve its safer use, as well as its more efficient circulation of heat upon thermal treatments.

FIG. 1A illustrates a typical fireproof container, and FIGS. 1B to 1E illustrate fireproof containers with improved circulation of heat and their safer use, according to one embodiment of the present invention, having prominent members 110.

Prominent member 110, of the fireproof container 100, may be provided at the corners of the rectangular container 100, as illustrated in FIG. 2A, or may be provided at the centers of four surfaces of the outer walls thereof, as illustrated in FIG. 2B.

Prominent member 110 may be provided in a vertical or horizontal orientation to the sides of the outer walls of the fireproof container 100, and may be provided at the upper portions of the sides of the outer walls of the fireproof container 100, as illustrated in FIG. 3A, or at the lower portions of the sides of the outer walls of the fireproof container 100, as illustrated in FIG. 3B.

Furthermore, the prominent member 110 may be provided on all of a left side surface, all of a right side surface, all of a front surface, and all of a rear surface of the outer walls of the fireproof container 100, and some of the prominent members 110 may be omitted.

More specifically, the prominent members may be provided on either the left side surface, or the right side surface, or at either the front surface or the rear surface, and may also be provided not only on any one of the left and right side surfaces, but also on any one of the front and rear surfaces.

The prominent member 110 of the fireproof container 100 may be formed to have an area corresponding to 40% or less, or may be formed to have an area corresponding to 30% or less of the total area of the outer walls thereof, in order to ensure a path for the circulation of the heat, and reduce a fireproof material.

Upon thermal treatment in an industrial furnace, the use of the fireproof container 100, according to one embodiment of the present invention, may result in more efficient circulation of the heat and its safer use.

More specifically, in RHK, which is a typical continuous furnace, fireproof containers may be arranged as illustrated in FIGS. 6C and 6D, and thus while the prominent members 110 on the sides of the fireproof containers 100 come into close contact with each other, the spaces 111 for the circulation of heat are defined to be between the fireproof containers adjacent to each other, thereby increasing the uniformity of the thermal treatment temperatures.

In cases where the conventional fireproof containers are arranged as illustrated in FIG. 6B, when the fireproof containers are individually moved into the furnace, differences in the intervals therebetween develop, and the direction of the movement(s) of the fireproof containers may deviate. However, the fireproof container 100, according to one embodiment of the present invention, is designed to be moved in a manner wherein the prominent member 110, of the fireproof container 100, is in close contact with another prominent member 110 of another fireproof container 100, and thus differences in the intervals between each fireproof container 100, or deviations in the direction of the movement(s) thereof, does not occur, thus improving the linear movement of the fireproof containers 100 and lowers the probability of generating incidents.

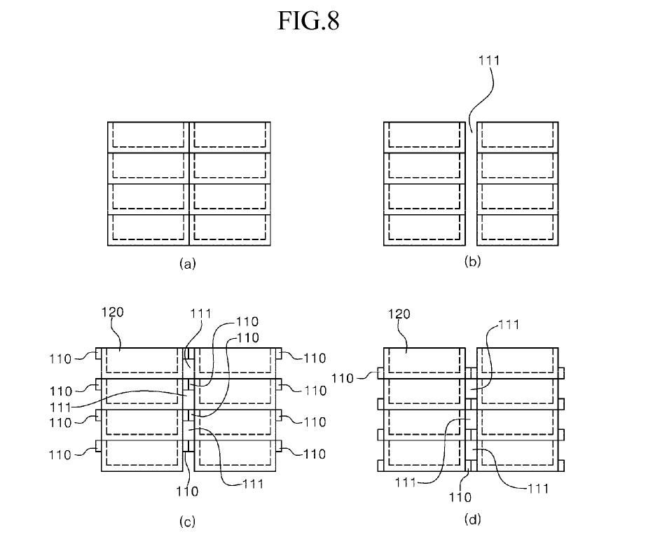

Furthermore, the fireproof container 100, according to one embodiment of the present invention, may also be used in a car kiln, which is a non-continuous furnace. In this case, these fireproof containers 100 may be loaded as illustrated in FIGS. 8C or 8D, and the prominent members 110 of the fireproof containers 100 are in close contact with each other and thus eliminates shaking, even during movement of the car 150, thereby increasing the safety of use thereof, and furthermore, the spaces 111, for the circulation of heat, are connected vertically and horizontally, thus increasing thermal treatment uniformity.

To manufacture the fireproof container 100 having the prominent member 110 as above, a mold or a gypsum mold with a space 120, having a predetermined volume complementary to the shape of the fireproof container 100 having the prominent member 110, is used, and individual ceramic materials in their powdered phase are weighed at a mixing ratio depending on the properties (e.g., end use, use temperature, product shape, strength, etc.) required for the fireproof containers 100.

The ceramic materials are added with water, or an organic additive, then are uniformly mixed using a mixer, placed in a mold and then pressed, thus producing a molded body for the fireproof container 100.

Subsequently, the molded body is dried at 50 to 150° C. to be dried, and the dried molded body is then fired in a thermal treatment furnace at 1200 to 1700° C. to ensure its predetermined strength, thus completing the fireproof container 100 with improved circulation of heat and its safer use.

Below is a detailed description of a fireproof container 100 with improved circulation of heat and its safer use, according to another embodiment of the present invention.

The fireproof container 100 with improved circulation of heat and safer use, according to another embodiment of the present invention, has a hexahedral shape with a space 120 having a predetermined volume wherein a powder or a target to be thermally treated is placed.

As such, the powder or target to be thermally treated may be any powder or target that needs thermal treatment. However, the fireproof container 100, according to one embodiment of the present invention, is used to thermally treat a lithium compound placed within the space 120 thereof.

The lithium compound is an important material useful in various industrial fields, and recently it has been mainly utilized as a positive electrode material for lithium secondary batteries.

As such, the positive electrode material containing lithium ions, acting as the energy source of the lithium secondary battery, is used in the form of a lithium metal oxide. In a lithium secondary battery, lithium ions and transition metal oxides undergo electrochemical intercalation/de-intercalation depending on charge and discharge properties, and various kinds of lithium positive electrode materials, such as LiCoO₂, LiNiO₂, LiNiₓCo_{y}Mn_{z}O₂, and the like, may be obtained depending on the transition metal oxide used.

The lithium positive electrode material is prepared by mixing a lithium compound, such as Li₂CO₃ or LiOH, with a transition metal precursor (e.g., Co, Mn, Ni, Fe, etc.) at a predetermined ratio to afford a mixture which is then placed in a thermal treatment container, followed by thermal treatment at about 700 to 1000° C. so that the lithium compound and the transition metal precursor react, thus preparing a lithium metal composite oxide for the positive electrode material of the lithium secondary battery.

Because the properties of the synthesized lithium metal composite oxide for a positive electrode material are sensitive to change, depending on the thermal treatment conditions, the thermal treatment conditions have to be uniformly controlled. To this end, the fireproof container 100 with improved circulation of heat and safer use, according to embodiments of the present invention, becomes required.

Concurrently, the fireproof container 100 with improved circulation of heat and safer use, according to another embodiment of the present invention, has a hexahedral shape with a space 120 having a predetermined volume, as stated above. As such, the hexahedral shape may be in the form of a rectangularly parallelepiped shape, or a cube.

Although the fireproof container 100 in a cubic shape, as above, may have a variety of sizes, it may have a width and length of 200 to 400 mm and a height of 5 to 150 mm in other embodiments of the present invention.

The reason why the size of the fireproof container 100 is limited, as above, is because the internal volume of the fireproof container 100 for thermal treatment becomes larger in proportion to its increased size, but if the size of the fireproof container 100 is enlarged, temperature variations in the container and inefficient gas emissions may take place with cracking caused by thermal impact, due to temperature variations between the inside and the outside of the container via the course of warming and cooling. Hence, the container is limited to a size optimal for preventing the above problems from occurring.

Also, the fireproof container 100 with improved circulation of heat and safer use, according to another embodiment of the present invention, includes a protrusion block 110 having a predetermined shape formed on at least one of the external front surface, rear surface, left side surface, and right side surface of the fireproof container 100.

As such, protrusion block 110 plays the same role(s) as the prominent member 110. As illustrated in FIGS. 1B to 1E, the protrusion block may be formed on the upper portion, lower portion, or center of the external edges of the fireproof container 100.

In addition to the above positions, the protrusion block 110 may also be formed on the upper portion, lower portion, or center of the external front surface, rear surface, left side surface, and right side surface of the fireproof container 100.

The protrusion block 110 may have various shapes, but may also be provided in the form of a rectangular parallelepiped extending in a horizontal direction in another embodiment of the present invention.

Furthermore, the protrusion block 110 may be formed at various heights depending on need, but may have a protrusion height of 5 to 15 mm in another embodiment of the present invention.

The reason why the protrusion height of the protrusion block 110 is limited to 5 to 15 mm, as above, is to solve the following problems. More specifically, if the protrusion height thereof is less than 5 mm, it is difficult to ensure adequate space for the circulation of heat and gases between the fireproof containers 100, undesirably causing differences in properties depending on the particle sizes of the positive electrode materials at different temperatures, and circulation of the gases becomes poor, wherein unreacted Li₂CO₃ and LiOH may be left behind due to low or non-emission of the CO₂ gas and H₂O vapors generated during the course of thermal treatments.

The protrusion block 110 may be separately manufactured and then attached to one surface of the fireproof container 100 using a ceramic adhesive.

However, in another embodiment of the present invention, the protrusion block 110 is integrally molded within the fireproof container 100 in order to prevent separation from the fireproof container 100.

The use of ceramic adhesives, as above, however, may incur the following problems.

More specifically, because the fireproof container 100 is thermally treated by repetitively passing it through alternating room temperatures and high temperatures (1200 to 1700° C.), the resultant differences in thermal expansion and shrinkage among the fireproof container 100, the adhesive, and the protrusion block 110, during the course of increasing and lowering of the temperature, may undesirably separate the adhesive surface during multiple uses of the container.

To overcome the above ceramic adhesive problems, the fireproof container 100 may be integrally molded with the protrusion block 110, as in one embodiment of the present invention. As such, the fireproof container 100 and the protrusion block 110 are made from the same material.

More specifically, the fireproof container 100 and the protrusion block 110 are made of any one, or a mixture of two or more, selected from the group consisting of alumina (Al₂O₃), silica (SiO₂), magnesia (MgO), zirconia (ZrO₂), and calcia (CaO).

In consideration of the heat resistance and corrosion resistance of the fireproof container 100, the sum of alumina, silica, and magnesia may be set to 90% or more.

The proportions of the individual components may vary depending on the kinds of parts and powders to be thermally treated, and the thermal treatment conditions. However, because the fireproof container 100, having the protrusion block 110, is difficult to mold due to the morphological properties thereof, materials, such as clay, having a silica component functions to improve moldability, and may be added in predetermined amounts of at least 10%.

Furthermore, the protrusion block 110, of the fireproof container 100, according to another embodiment of the present invention, is formed to occupy an area corresponding to 5 to 30% of the total area of the surface of the fireproof container on which the protrusion block 110 is formed.

The reason why the area occupied by the protrusion block is limited to 5 to 30% is as follows. More specifically, if the area thereof exceeds 30%, it is difficult to ensure a path for the circulation of the heat and gases, and energy losses may increase because the heat capacity is increased in proportion to an unnecessary increase in the weight of the fireproof container 100. In contrast, if the area thereof is less than 5%, there is an increasing risk of damaging the protrusion blocks 110 owing to contact between the fireproof containers 100, because contact occurs corresponding to the narrow areas. Hence, the area occupied by the protrusion block 110 is set to 5 to 30%.

Consequently, the fireproof container 100 with improved circulation of heat and safer use, according to one embodiment of the present invention, includes prominent member 110, or the protrusion block 110, having predetermined sizes on the outer surfaces thereof, as mentioned above, thus enabling more efficient circulation of the heat upon thermal treatments, and exhibiting safer use.

More specifically, the fireproof container 100 with improved circulation of heat and safer use, according to one embodiment of the present invention, facilitates the maintenance of the intervals between each of the adjacent fireproof containers 100, and thus the heat may be more uniformly and efficiently circulated in the furnace, ultimately increasing the uniformity of the thermal treatment. Furthermore, the increased linear movement(s) of the fireprood containers 100 may increase in RHK, and have zero shaking in a car kiln, concomitantly with zero rollover incidents.

As described herein, embodiments of the fireproof containers have improved circulation of heat and safer use. According to the embodiments of the present invention, the fireproof containers with improved circulation of heat and safer use include prominent members or protrusion blocks having predetermined sizes on the outer surfaces thereof and are thus more effective at efficiently circulating the heat during thermal treatments and ensure safer use.

According to the embodiments of the present invention, the fireproof containers with improved circulation of heat and safer use facilitate the maintenance of the intervals between the fireproof containers, and the fireproof containers adjacent to each other, thus more uniformly and efficiently circulating the heat in the furnace, thereby increasing thermal treatment uniformity. Furthermore, these fireproof containers can exhibit higher linear movement(s) in RHK, and do not shake in a car kilns with zero rollover incidents.

Although the embodiments herein have been disclosed for illustrative purposes, those skilled in the art will appreciate that various modifications, additions, and substitutions are possible, without departing from the scope and spirit of the invention as disclosed in the accompanying claims.

What is claimed is:

1. A fireproof container for thermal treatment of a powder or target, comprising a prominent member formed on an outer wall of the fireproof container.

2. The fireproof container of claim 1, wherein the prominent member is provided on an edge or a center of the outer wall of the fireproof container.

3. The fireproof container of claim 1, wherein the prominent member is provided in a vertical or horizontal orientation to the outer wall of the fireproof container.

4. The fireproof container of claim 1, wherein the prominent member is provided on an upper portion or a lower portion of the outer wall of the fireproof container.

5. The fireproof container of claim 1, wherein the prominent member is provided on all of a left side surface, a right side surface, a front surface, and a rear surface of the outer wall of the fireproof container, or is provided only on any one of the left side surface, the right side surface, the front surface, and the rear surface thereof.

6. The fireproof container of claim 1, wherein the prominent member is formed to have an area corresponding to 40% or less of a total area of the outer wall of the fireproof container.

7. A fireproof container for use in thermal treatment, the fireproof container having a hexahedral shape with a space having a predetermined volume in which a powder or a target to be thermally treated is placed, and comprising a protrusion block having a predetermined shape formed on at least one of the external front surface, rear surface, left side surface, and right side surface of the fireproof container.

8. The fireproof container of claim 7, wherein the protrusion block is formed on an upper portion, a lower portion, or a center of an external edge of the fireproof container.

9. The fireproof container of claim 7, wherein the protrusion block is formed on an upper portion, a lower portion, or a center of the external front surface, rear surface, left side surface, and right side surface of the fireproof container.

10. The fireproof container of claim 7, wherein the protrusion block has a hexahedral shape with a protrusion height of 5 to 15 mm.

11. The fireproof container of claim 7, wherein the protrusion block is integrally molded with the fireproof container to prevent separation from the fireproof container, and the fireproof container and the protrusion block comprise any one, or a mixture of two or more, selected from the group consisting of alumina (Al₂O₃), silica (SiO₂), magnesia (MgO), zirconia (ZrO₂), and calcia (CaO).

12. The fireproof container of claim 7, wherein the protrusion block is formed to occupy an area corresponding to 5 to 30% of a total area of the surface of the fireproof container on which the protrusion block is formed.
